(19) United States
(12) Patent Application Publication
(10) Pub. No.: US 2026/0134712 A1
(43) Pub. Date: May 14, 2026

(54) METHOD FOR PROVIDING PRIVACY ENABLED EYE TRACKING AND AN ELECTRONIC DEVICE FOR THE SAME

(71) Applicant: Samsung Electronics Co., Ltd., Suwon-si (KR)

(72) Inventors: Biplab Ch DAS, Bangalore (IN); Kiran Nanjunda IYER, Bangalore (IN); Anoop Kolar RAJAGOPAL, Bangalore (IN); Surabhi GUPTA, Bangalore (IN); M Dinesh PRABHU, Suwon-si (KR)

(21) Appl. No.: 19/252,862

(22) Filed: Jun. 27, 2025

Related U.S. Application Data
(63) Continuation of application No. PCT/KR2025/007187, filed on May 27, 2025.

(30) Foreign Application Priority Data
Nov. 13, 2024 (IN) 202411087837

(51) Int. Cl. G06V 40/18; G06F 3/01; G06F 21/62; G06T 7/62; G06T 11/00; G06T 15/06; G06T 17/10

(52) U.S. Cl. CPC G06V 40/193; G06F 3/013; G06F 21/6254; G06T 7/62; G06T 11/10; G06T 15/06; G06T 17/10; G06T 2207/30201

(57) ABSTRACT

According to an embodiment of the disclosure, a method for providing privacy enabled eye tracking performed by an electronic device may be provided. The method may include obtaining a first image of at least one eye of a user. The method may include extracting gaze information of the at least one eye, based on the first image. The method may include generating an image prompt based on the gaze information of the user. The method may include providing the image prompt with the gaze information to a pre-trained artificial intelligence (AI) model to generate a second image of the at least one eye of the user. The biometric information of the at least one of the user may be anonymized in the second image.

### CROSS-REFERENCE TO RELATED APPLICATION(S)

This application is a continuation application, claiming priority under 35 U.S.C. § 365(c), of an International application No. PCT/KR2025/007187, filed on May 27, 2025, which is based on and claims the benefit of an Indian patent application number 202411087837, filed on Nov. 13, 2024, in the Indian Patent Office, the disclosure of which is incorporated by reference herein in its entirety.

### FIELD OF TECHNOLOGY

The disclosure relates to the field of head mounted devices. More particularly, the disclosure relates to method and an electronic device for providing privacy enabled eye tracking.

### BACKGROUND

Eye-tracking technology has gained significant prominence, particularly in the fields of virtual reality (VR) and augmented reality (AR), due to its ability to track and measure eye movements, point of gaze, and blink patterns. This technology allows researchers and developers to observe the visual attention of users, monitor engagement, and identify what is being ignored.

Eye-tracking systems not only capture ballistic movements of the eyes, but also provide continuous recordings of pupil diameter. These recordings offer insights into cognitive states, helping to interpret mental processes, especially in contexts like medical image analysis.

Typically, an eye-tracking system comprises one or more cameras, light sources (e.g., light emitting diodes (LEDs)), and computing units that run image processing technique designed to analyze the camera feeds. By leveraging machine learning and advanced image processing, the eye-tracking system computes gaze direction, eye position, and related metrics. The captured data, however, can reveal sensitive biometric information about the user, such as identity, gender, age, ethnicity.

Existing eye-tracking solutions face significant privacy challenges. Many current eye tracking systems rely on post-processing sensor data, making them vulnerable to hacking, if iris modifications are not done at the hardware level. Deep learning architectures for eye tracking often require raw eye images, making the data susceptible to privacy breaches. Additionally, many eye-tracking databases store raw eye data without anonymizing it, further exposing sensitive user information.

Moreover, attempts to anonymize eye images by modifying iris regions can interfere with the refraction properties of the eye, reducing the accuracy of geometry-based eye-tracking solutions. This limitation hinders the use of third-party machine learning models that rely on unaltered eye data.

In VR and AR applications, eye-tracking is integral to enhancing user experience. However, these applications often require access to eye data that contains personal identifiable information, raising significant privacy concerns. Anonymizing eye data without compromising its utility in VR/AR interactions is therefore desired. The ability to anonymize and use eye data effectively also holds promise in medical applications, such as autism diagnosis, where gaze analysis is used to detect behavioral patterns.

To address these challenges, there is a need for a methodology that ensures privacy by anonymizing eye data while preserving its accuracy for eye-tracking and interaction purposes in eye tracking pipeline applications. In view of the foregoing discussion, there exists a need in the art for an eye tracking strategy that provides anonymizing of eye data in real time to aid the effective use of eye data and overcome the above-mentioned limitations present in the existing technologies.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide method and system for providing privacy enabled eye tracking in an electronic device.

Additional aspects will be set forth in part in the description which follows and, in part, will be apparent from the description, or may be learned by practice of the presented embodiments.

According to an embodiment of the disclosure, a method for providing privacy enabled eye tracking performed by an electronic device may be provided. The method may include obtaining a first image of at least one eye of a user. The method may include extracting gaze information of the at least one eye, based on the first image. The method may include generating an image prompt based on the gaze information of the user. The method may include providing the image prompt with the gaze information to a pre-trained artificial intelligence (AI) model to generate a second image of the at least one eye of the user. The biometric information of the at least one of the user may be anonymized in the second image.

According to an embodiment of the disclosure, an electronic device for providing privacy enabled eye tracking. may be provided. The electronic device may include memory storing one or more instructions, at least one processor communicatively coupled to the memory. The instructions when executed by the at least one processor individually or collectively, cause the electronic device to obtain a first image of at least one eye of a user. The instructions when executed by the at least one processor individually or collectively, cause the electronic device to extract gaze information of the at least one eye, based on the first image. The instructions when executed by the at least one processor individually or collectively, cause the electronic device to generate an image prompt based on the gaze information of the user. The instructions when executed by the at least one processor individually or collectively, cause the electronic device to provide the image prompt with the gaze information to a pre-trained artificial intelligence (AI) model to generate a second image of the at least one eye of the user. The biometric information of the at least one of the user may be anonymized in the second image.

According to an embodiment of the disclosure, one or more non-transitory computer-readable storage media storing instructions that, when executed by at least one processor of an electronic device individually or collectively, cause the electronic device to perform operations may be provided. The operation may comprise obtaining a first image of at least one eye of a user. The operation may comprise extracting gaze information of the at least one eye, based on the first image. The operation may comprise generating an image prompt based on the gaze information of the user. The operation may comprise providing the image prompt with the gaze information to a pre-trained artificial intelligence (AI) model to generate a second image of the at least one eye of the user. The biometric information of the at least one of the user may be anonymized in the second image.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment for providing privacy enabled eye tracking in an electronic device according to an embodiment of the disclosure;

FIG. 2 illustrates a method for three-dimensional (3D) eye model generation according to an embodiment of the disclosure;

FIG. 3 illustrates a block diagram for determining gaze information of a 3D eye model according to an embodiment of the disclosure;

FIG. 4 illustrates a block diagram for eye image generation by a privacy enabled system according to an embodiment of the disclosure;

FIG. 5 illustrates a block diagram for anonymized eye image generation by the privacy enabled system according to an embodiment of the disclosure;

FIG. 6 illustrates a block diagram of a system for providing privacy enabled eye tracking in an electronic device according to an embodiment of the disclosure; and

FIG. 7 illustrates a flowchart for a method for providing privacy enabled eye tracking in an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration”. Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It can be understood, however, that it is not intended to limit the disclosure to the particular forms disclosed, but on the contrary, the disclosure is to cover a plurality of modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part thereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

The terminology “Artificial intelligence (AI) model” and “neural network” are interchangeably used throughout the specification. The AI module may be a combination of hardware module and software module. The hardware module may comprise necessary circuitry to perform the functionality discussed in the embodiments below.

The terminology “3D” and “three dimensional” may have same meaning and may be alternatively used throughout the specification.

The terminology “gaze information” and “eye tracking information” may have same meaning and may be alternatively used throughout the specification. The gaze information may refer to data related to eye movement of a user, eye status of the user and gaze direction of the user. The gaze information may include at least one of eye movement, blink duration, blink frequency, gaze position (e.g., coordinates of the positions where the user is looking), fixation points, saccades, smooth pursuit (e.g., the ability of the eyes to follow a moving object smoothly), and ocular tremor.

Embodiments of the disclosure relate to a method and an electronic device for providing privacy enabled eye tracking. According to an embodiment of the disclosure, the electronic device and method introduces a framework that generates fake eye images for eye-tracking applications by preserving gaze information and protecting user privacy. The electronic device may generate a de-refracted 3D eye model and may use a diffusion model to create synthetic eye images based on eye images received from the user. Further, the method and system of the disclosure ensures that biometric eye data is never exposed to external systems. This approach allows for high-quality eye tracking without compromising user identity and enables third-party solutions to utilize the anonymized data for interactions and analysis.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

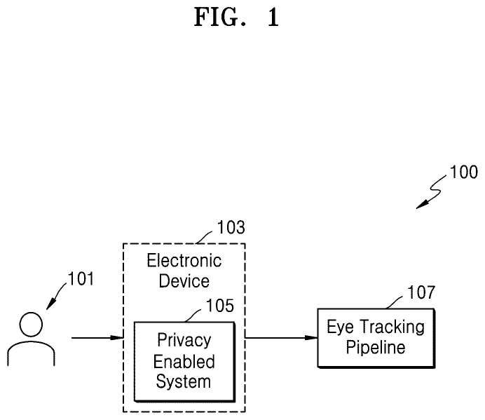

FIG. 1 illustrates an environment 100 for providing privacy enabled eye tracking in an electronic device according to an embodiment of the disclosure.

The environment 100 depicts a user 101, an electronic device 103 comprising a privacy enabled system 105, and an eye tracking pipeline 107. In one non-limiting embodiment, the privacy enabled system 105 may be externally connected to the electronic device 103.

The privacy enabled system 105 may be configured to receive one or more images of at least one eye of the user 101 and provide a second image of the user's eye to the eye tracking pipeline 107. The eye tracking pipeline 107 may include an electronic device for eye tracking. The electronic device for eye tracking may be referred to as a second electronic device. For example, the electronic device for eye tracking may be an external electronic device for tracking gaze of the user 101. The second image of the user's eye retains the gaze information of the user, whereas the biometric information of the eye of the user 101 is anonymized. The biometric information may refer to information that may be used to identify the user directly or indirectly. The biometric information may vary from user to user. For example, the biometric information may include user-specific information as well as the unique information. For example, biometric information related to the eyes may include characteristics of the iris (e.g., iris pattern, eye color, iris texture), characteristics of the pupil (e.g., pupil size, pupil reactivity), and characteristics of the face (e.g., wrinkles around the eyes, eye shape, skin color, etc.). The generation of the second image is discussed in further detail in the embodiments below.

The eye tracking pipeline 107 may be configured to provide the user's gaze or eye tracking information to one or more applications. The user's eye tracking information may be used to improve the user experience in augmented reality (AR) or virtual reality (VR) related applications.

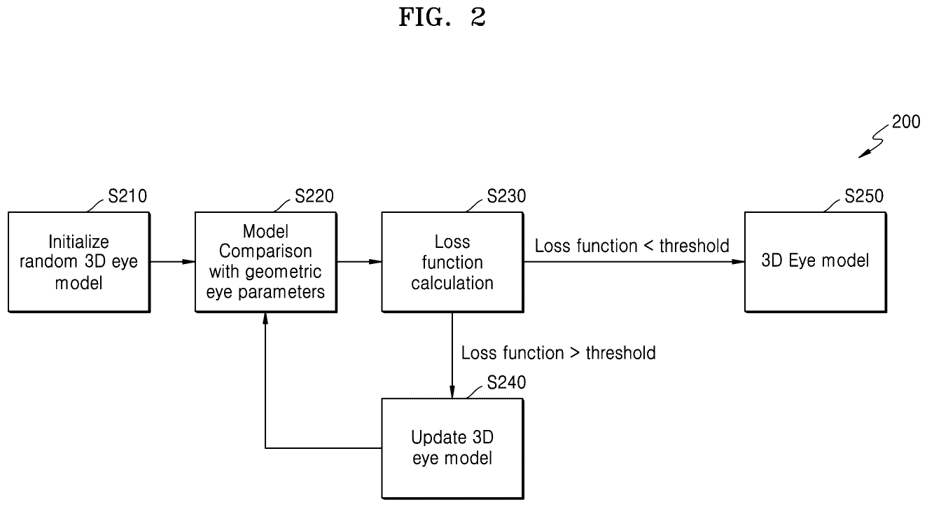

FIG. 2 illustrates a method 200 for 3D eye model generation according to an embodiment of the disclosure.

Referring to FIG. 2, at least one eye image of a user may be received by the privacy enabled system. In an embodiment, an image of a left eye or an image of a right eye may be separately captured by one or more cameras (not shown) and provided as input to the privacy enabled system. In one non-limiting embodiment, both left and right eye image may be taken as input. The at least one eye image may comprise biometric information as well as gaze information of the user.

Thereafter, feature extraction may be performed by the privacy enabled system using a feature extraction technique on the at least one eye image to extract geometric eye parameters. In an embodiment, any feature extraction technique known to person skilled in the art may be implemented to extract geometric eye parameters. For example, the segmentation may be performed on the eye images to estimate the 2D features of the eye. In an eye image, the pupil region, iris region, and sclera region may be divided on a pixel basis. The geometric eye parameters may be obtained based on the pupil region, iris region, and sclera region. For example, the geometrical parameters of the eye may be calculated from the size, shape, proportion, or area of the region. The geometric eye parameters may be parameters that represent the structure of the eye. For example, the geometric eye parameters may include at least one of an eye radius, a cornea radius, cornea information, ellipses of pupils, iris information, and a cornea index of refraction. The geometric eye parameters are not limited to above examples and any other geometric eye parameter that may be used to may be used to generate a three-dimensional (3D) eye model and known to a person skilled in the art is well within the scope of disclosure.

The geometric eye parameters may be used to generate the 3D eye model of the user's eye from the at least one eye image. Firstly, a random 3D eye model is initialized for generating the 3D eye model of the user's eye, at operation S210. Thereafter, the random 3D eye model is updated based on the geometric eye parameters. At least one of a geometric property or an optic property of the 3D eye model may be determined based on the geometric eye parameters. For example, the corneal radius is the geometric eye parameter that determine the shape of the 3D eye model. The corneal radius is the geometric eye parameter that determine the way light being refracted. The updated 3D eye model is then compared to the geometric eye parameters in operation S220 to determine a loss function at operation S230. The loss function indicates the deviation of the 3D eye model from the geometric eye parameters.

In the next step, the 3D eye model is iteratively updated till the loss function is less than a pre-determined threshold. The 3D eye model may be updated, at operation S240 by adjusting the geometric and optic properties of the 3D eye model based on the loss function. The geometric property may refer to a physical characteristic of the 3D eye model structure. The optic property may refer to an optical characteristic of how the 3D eye model interacts with light. In order to anonymize the biometric information of the eye, the electronic device may modify the texture information of the eye in the 3D eye model such that the eye color information in the at least one eye image does not match the eye color information in the 3D eye model. Further, the electronic device may randomize eye color information of the eye in the 3D eye model such that the eye color information in the at least one eye image does not match the eye color information in the 3D eye model. Moreover, the electronic device may remove the iris information from the eye in the 3D eye model. Lastly, the electronic device may randomize skin contrast information of the eye in the 3D eye model such that the skin contrast information in the at least one eye image does not match the skin contract information in the 3D eye model. In one non-limiting embodiment, different combinations of one or more randomization may be applied to generate the image prompt of the user eye.

Once the loss function is less than the predetermined threshold, at operation S250, the finally updated 3D eye model is provided as a 3D eye model of the at least one eye image. In one non-limiting embodiment, the method 200 for 3D eye model generation may be implement using an AI model. The AI model may be configured to perform above mention operations and generate a 3D eye model based on the geometric eye parameters.

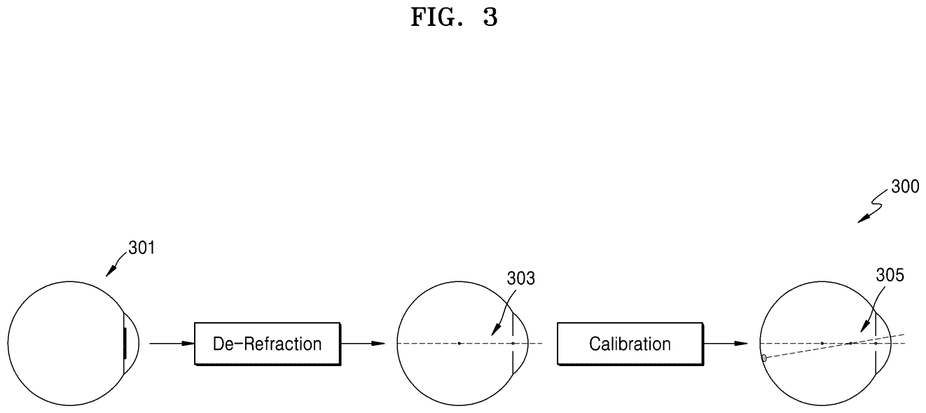

The 3D eye model may comprise the gaze information and geometric eye parameters (e.g., physiological eye parameters) of the user eye from the at least one eye image of the user. The 3D eye model may be processed to obtain gaze information by generating an image prompt corresponding to the user's eye. The image prompt may refer to an image given to Artificial Intelligence (AI) model to generate an image of at least one eye. For example, the image prompt may be a gray scale image generated by projecting 3D eye model onto an image plane. The generation of the image prompt is discussed in further detail in the embodiments below. FIG. 3 illustrates a block diagram for determining gaze information from a 3D eye model according to an embodiment of the disclosure.

Referring to FIG. 3, the 3D eye model generated based on the user's eye image may be processed by the privacy enabled system 300 (discussed in above embodiments) to obtain gaze information of the eye. The 3D eye model 301 may be a mathematical representation that includes the structural and positional information of the eye with respect to the camera.

The feature extraction may be performed on the eye image to extract geometric eye parameters. The geometric eye parameters may be used to define the 3D eye model and obtain the gaze information. According to an embodiment, in the eye image, the pupil may be detected. For example, a pixel below a defined threshold in the image may be set as the pupil region. The edge of the pupil may be detected to extract the boundary of the pupil. Also, for example, a circular or oval structure may be detected to extract the center of the pupil. In the eye image, the glint of the cornea may be detected. The glint of the cornea may be an optical reference point.

Initially, the geometric eye parameters of the 3D eye model 301 may be de-refracted by the privacy enabled system using a de-refraction technique to obtain an optical axis 303. In one non-limiting embodiments, any other technique for obtaining the optical axis 303 from the 3D eye model is well within the scope of disclosure.

Thereafter, the optical axis 303 of the de-refracted 3D eye model may be calibrated by the privacy enabled system based on one or more calibration parameters to obtain a gaze information 305 of the user. The gaze information 305 may be obtained by calibrating an angular difference from the optical axis 305 to a gaze axis of the 3D eye model.

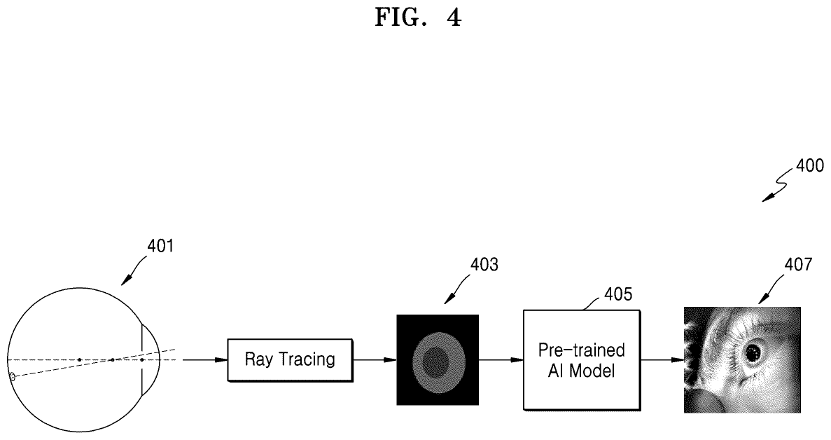

FIG. 4 illustrates a block diagram for eye image generation by the privacy enabled system 400 according to an embodiment of the disclosure.

In an embodiment of the disclosure, a de-refracted 3D eye model 401 may be projected as an image prompt 403 by the privacy enabled system. For this purpose, the privacy enabled system may perform ray tracing on the de-refracted 3D eye model 401. In one non-limiting embodiments, any other projection technique for image prompt generation is well within the scope of disclosure.

The image prompt 403 may comprise information related to the corresponding to the de-refracted 3D eye model 401 including the gaze information of the user. The image prompt 403 may be provided as input to a pre-trained AI model 405 for obtaining a anonymized image 407 of the user's eye. The anonymized image 407 may comprise the gaze information of the user without any biometric information.

The pre-trained AI model 405 may perform a ControlNet based diffusion on the image prompt 403 to anonymize the biometric information present in the image prompt 403 while retaining the gaze information of the user. For this purpose, the pre-trained AI model 405 model may perform ControlNet diffusion to generate the anonymized image 407. The anonymized image 407 may have different texture information, eye color information, skin contract information, and iris information of the eye from input eye image. The generation of an anonymized image of the user's eye is discussed in further detail in the embodiments below.

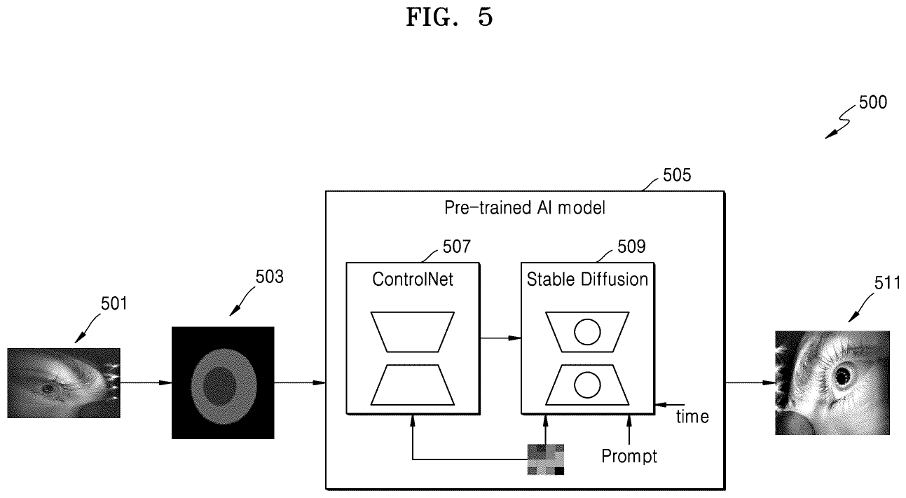

FIG. 5 illustrates a block diagram for anonymized eye image generation by the privacy enabled system according to an embodiment of the disclosure.

In an embodiment of the disclosure, at least one eye image 501 of a user may be projected as an image prompt 503 by the privacy enabled system 500. The generation of the image prompt 503 is discussed in detail in the above embodiments.

Thereafter, the image prompt 503 may be provided as an input to a pre-trained AI model 505. In an embodiment, the pre-trained AI model 505 may be similar to the pre-trained AI models of FIGS. 1 and 4. In one non-limiting embodiment, the pre-trained AI model may be implemented using Gen AI synthesizer module.

The pre-trained AI model 505 may comprise a ControlNet 507 and a stable diffusion encoder model 509 for performing a ControlNet based diffusion on the image prompt 503 to generate an anonymized image 511 of the eye of the user. To generate the anonymized image 511, the pre-trained AI model 505 may use the image prompt 503 while retaining the gaze information of the user.

For this purpose, the pre-trained AI model 505 may perform ControlNet diffusion to generate the anonymized image 511. The pre-trained AI model 505 may generate the anonymized image 511 based on the image prompt 503. The image prompt may include different texture information, eye color information, skin contract information and iris information of the eye from the at least one eye image 501. The ControlNet 507 may control and reuse the stable diffusion encoder model 509 to learn diverse controls to generate the anonymized image 511. For this purpose, the image prompt 503 may be compressed into a latent image. The image prompt 503 may be used to generate the anonymized image 511 with anonymized the biometric information. The text prompt may be used to generate the anonymized image, with the image prompt 503. The text prompt may refer to a text given to Artificial Intelligence (AI) model to guide the generation task. The text prompt may be encoded into a feature vector which is given as an input to the stable diffusion encoder model 509.

The anonymized image 511 of the user's eye generated by the pre-trained AI model 505 may be provided to an eye tracking pipeline which may provide the gaze information of the user from the anonymized image 511 to AR and VR based applications that require eye tracking or gaze information.

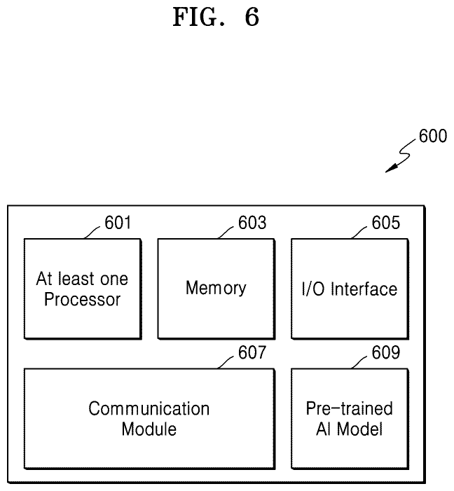

FIG. 6 illustrates a block diagram of a system 600 for providing privacy enabled eye tracking in an electronic device according to an embodiment of the disclosure. In one embodiment, the system 600 may be similar to the privacy enabled system discussed in reference with FIGS. 1, 2, 3, 4, and 5.

In an embodiment of the disclosure, the system 600 may comprise memory 603, at least one processor 601, an input/output (I/O) interface 605, a pre-trained AI model 609 and a communication module 607 communicatively coupled with each other.

It may be noted that, in some embodiments, the system 600 may include more or fewer components than those depicted herein. The various components of the system 600 may be implemented using hardware, software, firmware or any combinations thereof. Further, the various components of the system 600 may be operably coupled with each other. More specifically, various components of the system 600 may be capable of communicating with each other using communication channel media (such as buses, interconnects, etc.).

In one embodiment, the at least one processor 601 may be embodied as a multi-core processor, a single core processor, or a combination of one or more multi-core processors and one or more single core processors. For example, the at least one processor 601 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In one embodiment, the memory 603 is capable of storing machine executable instructions, referred to herein as instructions. In an embodiment, the at least one processor 601 is embodied as an executor of software instructions. As such, the at least one processor 601 is capable of executing the instructions stored in the memory 603 to perform one or more operations described herein.

The memory 603 can be any type of storage accessible to the at least one processor 601 to perform respective functionalities. For example, the memory 603 may include one or more volatile or non-volatile memories, or a combination thereof. For example, the memory 603 may be embodied as semiconductor memories, such as flash memory, mask read only memory (ROM), programmable ROM (PROM), erasable PROM (EPROM), random access memory (RAM), etc. and the like.

The at least one processor 601 may be configured to receive a first image of at least one eye of a user for generating an anonymized image of the user's eye. The first image of at least one eye may be captured using an image sensor. In one non-limiting embodiment, the at least one processor 601 may be configured to receive the first image of at least one eye via the I/O interface 605.

Thereafter, the at least one processor 601 may be configured to process the first image to extract gaze information of the user. The processing may require the at least one processor 601 to perform feature extraction on the first image to extract geometric eye parameters associated with the at least one eye. The geometric eye parameters may include at least one of an eye radius, cornea radius, cornea information, ellipses of pupils, iris information, and index of refraction. In an embodiment, any feature extraction technique known to a person skilled in the art may be applied to extract the above mentioned geometric eye parameters.

For the processing, the at least one processor 601 may be then configured to generate a 3D eye model at least based on the geometric eye parameters and process the 3D eye model to generate an image prompt corresponding to the first image of the at least one eye.

For generation of the 3D eye model, the at least one processor 601 may be configured to initialize a random 3D eye model for the first image and update the random 3D eye model based on the geometric eye parameters until a loss function is less than a predetermined threshold, and provide the 3D eye model based on the updated random 3D model. To update the random eye model, the at least one processor 601 may be configured to iteratively perform the step of compare the random 3D eye model with the geometric eye parameters to calculate the loss function, the loss function indicating the deviation of random 3D eye model from the geometric eye parameters, determine whether the loss function is less than the predetermined threshold, and adjust the geometric and optic properties of the random eye model based on the loss function, if the loss function is greater than a predetermined threshold.

In an embodiment, the 3D eye model may comprise the gaze information and other biometric and physiological eye parameters of the eyes from the at least one image of the user's eye.

Thereafter, at least one processor 601 may be configured to process the 3D eye model to generate an image prompt. For this purpose, the at least one processor 601 may be configured to de-refract, using de-refraction technique, the geometric eye parameters of the 3D eye model to generate de-refracted eye parameters, estimate an optical axis of the de-refracted 3D eye model using the de-refracted geometric eye parameters, calibrate the optical axis with a plurality of calibration parameters to obtain the gaze information of the user, and perform the ray tracing on the de-refracted 3D eye model to project the de-refracted 3D eye model as the image prompt.

The image prompt generated by the at least one processor 601 may comprise information related to the user's eye including biometric information and the gaze information of the user from at least one image of the user's eye. After the image prompt is generated, the at least one processor 601 may be configured to provide the image prompt with gaze information to the pre-trained AI model to generate a second image of the at least one eye of the user. The second image of the user's eye may be similar to anonymized eye image discussed in above embodiments. The second image of the user's eye comprises the gaze information of the user without anonymized biometric information.

In an embodiment, the pre-trained AI model 609 may be configured to perform a ControlNet based diffusion on the image prompt to anonymize the biometric information present in the image prompt while retaining the gaze information of the user's eye.

To anonymize the biometric information of the user in the second image, the pre-trained AI model 609 may be configured to perform ControlNet diffusion to change the texture information, eye color information, skin contract information and iris information of the eye. For this purpose, the pre-trained AI model 609 may be configured to compress the image prompt to translate the image prompt into latent space. Then, the pre-trained AI model 609 may be configured to perform ControlNet diffusion on the latent space image using one or more noise parameters to generate a second image of the user's eye comprising of gaze information and anonymized biometric information.

In order to modify the texture information of the eye, the pre-trained AI model 609 may be configured to generate the second image of the user's eye such that the texture information of the eye in the second image of the user's eye is different from the texture information in the at least one image of the user's eye. Further, the pre-trained AI model 609 may be configured to randomize eye color information of the eye of the 3D eye model in a manner that the eye color information in the second image of the user's eye differs from the eye color information in the at least one image of the user's eye. Moreover, the pre-trained AI model 609 may be configured to remove the iris information from the eye of the 3D eye model. Lastly, the pre-trained AI model 609 may be configured to randomize the skin contrast information of the eye of the 3D eye model such that the skin contrast information in the at least one image of the user's eye does not match the skin contract information in the second image of the user's eye.

Once the second image of the user's eye is generated by the pre-trained AI model 609, the at least one processor 601 may be configured to provide the second image of the user's eye as input via the communication module 607 to an eye tracking pipeline. The eye tracking pipeline may provide the gaze information of the user from the second image of the user's eye to AR-VR based applications that require eye tracking information.

In one embodiment, the pre-trained AI model 609 may be configured to receive a sample set of images and a sample set of randomized noise parameters. The one or more sample set of images may be image prompts of eye images, such that the image prompts comprise biometric information as well as gaze information of the eyes. Furthermore, the pre-trained AI model 609 may be trained to compress the sample set of images to translate the images in latent space. The latent space images and the set of randomized noise parameters may be used to train the pre-trained AI model 609 to generate a plurality of eye images that preserve the gaze information and remove the biometric information.

Thus, the system 600 facilitates high-quality eye tracking without compromising user identity and enables third-party solutions to utilize the anonymized data for interactions and analysis.

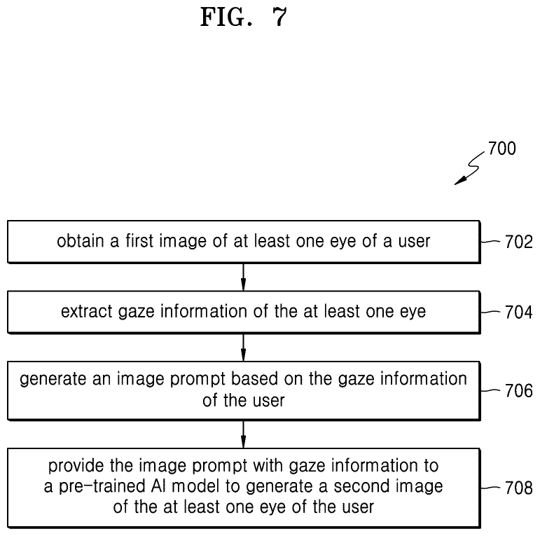

FIG. 7 illustrates a flowchart for a method 700 for providing privacy enabled eye tracking in an electronic device according to an embodiment of the disclosure.

At operation 702, the method 700 discloses obtaining a first image of at least one eye of a user. The first image comprises information about the user's eye including gaze information, geometric parameters of the eye, and physiological information of the eye.

At operation 704, the method 700 discloses processing the first image to extract gaze information of the user. At this step, processing includes performing feature extraction on the first image to extract geometric eye parameters associated with the at least one eye, generating a 3D eye model at least based on the geometric eye parameters, and processing the 3D eye model to generate an image prompt corresponding to the first image of the at least one eye. In an embodiment, the geometric eye parameters may include at least one of an eye radius, cornea radius, cornea information, ellipses of pupils, iris information, and index of refraction.

For generating the 3D eye model, the method 700 may comprise initializing a random 3D eye model for the first image, updating the random 3D eye model based on the geometric eye parameters until a loss function is less than a predetermined threshold, and providing the 3D eye model based on the updated random 3D model. For updating the random eye model, the method 700 comprises iteratively performing the step of comparing the random 3D eye model with the geometric eye parameters to calculate the loss function, determining whether the loss function is less than the predetermined threshold, and adjusting the geometric and optic properties of the random eye model based on the loss function, if the loss function is greater than a predetermined threshold. The loss function may indicate the deviation of random 3D eye model from the geometric eye parameters and may be used to obtain an accurate 3D eye model.

For adjusting geometric and optic properties corresponding to each of the geometric eye parameters of the random 3D eye model, the method 700 includes performing, by the pe-trained AI model, ControlNet diffusion to change the texture information, eye color information, skin contract information and iris information of the eyes. In an embodiment, for adjusting geometric and optic properties corresponding to each of the geometric eye parameters of the 3D eye model, the method 700 comprises modifying texture information of the random 3D eye model corresponding to at least one eye, randomizing eye color information of the random 3D eye model corresponding to the at least one eye, removing the iris information from the random 3D eye model corresponding to the at least one eye, and randomizing skin contrast information of the random 3D eye model corresponding to the at least one eye.

At operation 706, the method 700 discloses generating an image prompt at least based on the gaze information of the user and the 3D eye model. For this purpose, the method 700 may comprise de-refracting, using de-refraction technique, the geometric eye parameters of the 3D eye model to generate de-refracted geometric eye parameters, estimating an optical axis of the de-refracted 3D eye model using the de-refracted geometric eye parameters, calibrating the optical axis with a plurality of calibration parameters to obtain the gaze information of the user, and performing the ray tracing on the de-refracted 3D eye model to project the de-refracted 3D eye model as the image prompt.

Thereafter, at operation 708, the method 700 discloses providing the image prompt with gaze information to a pre-trained AI model to generate a second image of the at least one eye of the user.

In an embodiment, the method further comprises providing, to the pre-trained AI model, a sample set of images and a sample set of randomized noise parameters, compressing the sample set of images to translate the images in latent space, and training the pre-trained AI model based on the latent space images and the set of randomized noise parameters to generate a plurality of eye images without biometric information.

Thus, the method 700 ensures that actual biometric eye data is never exposed to external systems. Further, the method 700 also provides high-quality eye tracking without compromising user identity and enables third-party solutions to utilize the anonymized data for interactions and analysis.

The sequence of operations of the method 700 need not be necessarily executed in the same order as they are presented. Further, one or more operations may be grouped together and performed in form of a single step, or one operation may have several sub-steps that may be performed in parallel or in sequential manner.

The disclosed method with reference to FIG. 7, or one or more operations of the system 600 explained with reference to FIG. 7 may be implemented using software including computer-executable instructions stored on one or more computer-readable media (e.g., non-transitory computer-readable media, such as one or more optical media discs, volatile memory components (e.g., dynamic random access memory (DRAM) or static random access memory (SRAM)), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” may be understood to include tangible items and exclude carrier waves and transient signals, i.e., be non-transitory. Examples include Random Access Memory (RAM), Read-Only Memory (ROM), volatile memory, non-volatile memory, hard drives, Compact Disc (CD) ROMs, digital versatile discs (DVDs), flash drives, disks, and any other known physical storage media.

According to an embodiment of the disclosure, a method for providing privacy enabled eye tracking performed by an electronic device may be provided. The method may include obtaining a first image of at least one eye of a user. The method may include extracting gaze information of the at least one eye, based on the first image. The method may include generating an image prompt based on the gaze information of the user. The method may include providing the image prompt with the gaze information to a pre-trained artificial intelligence (AI) model to generate a second image of the at least one eye of the user. The biometric information of the at least one of the user may be anonymized in the second image.

According to an embodiment of the disclosure, the method may include providing the second image to a second electronic device for tracking gaze of the user.

According to an embodiment of the disclosure, the method may include performing feature extraction on the first image to extract geometric eye parameters associated with the at least one eye. The method may include generating a three-dimensional (3D) eye model based on the geometric eye parameters. The method may include obtaining the gaze information of the user based on the 3D eye model.

According to an embodiment of the disclosure, the geometric eye parameters may include at least one of eye radius, cornea radius, cornea information, ellipses of pupils, iris information, and index of refraction.

According to an embodiment of the disclosure, the method may include initializing a random 3D eye model for the first image. The method may include updating the random 3D eye model based on the geometric eye parameters until a loss function is less than a predetermined threshold. The method may include comparing parameter of the random 3D eye model corresponding to each of the geometric eye parameters with each of the geometric eye parameters to calculate the loss function. The loss function may indicate deviation of the random 3D eye model from each of the geometric eye parameters. The method may include determining whether the loss function is less than the predetermined threshold. The method may include adjusting geometric and optic properties corresponding to each of the geometric eye parameters of the random 3D eye model based on the loss function, if the loss function is greater than a predetermined threshold. The method may include providing the 3D eye model based on the updated random 3D model.

According to an embodiment of the disclosure, the method may include de-refracting, using a de-refraction technique, the geometric eye parameters of the 3D eye model to generate de-refracted geometric eye parameters. The method may include estimating an optical axis of the de-refracted 3D eye model using the de-refracted geometric eye parameters. The method may include calibrating the optical axis with a plurality of calibration parameters to obtain the gaze information of the user. The method may include performing ray tracing on the de-refracted 3D eye model to project the de-refracted 3D eye model as the image prompt.

According to an embodiment of the disclosure, the method may include modifying texture information of the random 3D eye model corresponding to at least one eye. The method may include randomizing eye color information of the random 3D eye model corresponding to the at least one eye. The method may include removing iris information from the random 3D eye model corresponding to the at least one eye. The method may include randomizing skin contrast information of the random 3D eye model corresponding to the at least one eye.

According to an embodiment of the disclosure, the method may include providing, to the pre-trained AI model, a sample set of images and a sample set of randomized noise parameters. The method may include compressing the sample set of images to translate the images in latent space. The method may include training the pre-trained AI model based on the translated set of images and the set of randomized noise parameters to generate a plurality of eye images without biometric information.

According to an embodiment of the disclosure, an electronic device for providing privacy enabled eye tracking. may be provided. The electronic device may include memory storing one or more instructions, at least one processor communicatively coupled to the memory. The instructions when executed by the at least one processor individually or collectively, cause the electronic device to obtain a first image of at least one eye of a user. The instructions when executed by the at least one processor individually or collectively, cause the electronic device to extract gaze information of the at least one eye, based on the first image. The instructions when executed by the at least one processor individually or collectively, cause the electronic device to generate an image prompt based on the gaze information of the user. The instructions when executed by the at least one processor individually or collectively, cause the electronic device to provide the image prompt with the gaze information to a pre-trained artificial intelligence (AI) model to generate a second image of the at least one eye of the user. The biometric information of the at least one of the user may be anonymized in the second image.

According to an embodiment of the disclosure, the instructions when executed by the at least one processor individually or collectively, may cause the electronic device to provide the second image to a second electronic device for tracking gaze of the user.

According to an embodiment of the disclosure, the instructions when executed by the at least one processor individually or collectively, may cause the electronic device to perform feature extraction on the first image to extract geometric eye parameters associated with the at least one eye. The instructions when executed by the at least one processor individually or collectively, may cause the electronic device to generate a three-dimensional (3D) eye model based on the geometric eye parameters. The instructions when executed by the at least one processor individually or collectively, may cause the electronic device to obtain the gaze information of the user based on the 3D eye model.

According to an embodiment of the disclosure, the geometric eye parameters may include at least one of eye radius, cornea radius, cornea information, ellipses of pupils, iris information, and index of refraction.

According to an embodiment of the disclosure, the instructions when executed by the at least one processor individually or collectively, may cause the electronic device to initialize a random 3D eye model for the first image. The instructions when executed by the at least one processor individually or collectively, may cause the electronic device to update the random 3D eye model based on the geometric eye parameters until a loss function is less than a predetermined threshold. The instructions when executed by the at least one processor individually or collectively, may cause the electronic device to compare parameter of the random 3D eye model corresponding to each of the geometric eye parameters with each of the geometric eye parameters to calculate the loss function, wherein the loss function indicates deviation of the random 3D eye model from each of the geometric eye parameters. The instructions when executed by the at least one processor individually or collectively, may cause the electronic device to determine whether the loss function is less than the predetermined threshold. The instructions when executed by the at least one processor individually or collectively, may cause the electronic device to adjust geometric and optic properties corresponding to each of the geometric eye parameters of the random 3D eye model based on the loss function, if the loss function is greater than a predetermined threshold. The instructions when executed by the at least one processor individually or collectively, may cause the electronic device to provide the 3D eye model based on the updated random 3D model.

According to an embodiment of the disclosure, the instructions when executed by the at least one processor individually or collectively, may cause the electronic device to de-refract, using a de-refraction technique, the geometric eye parameters of the 3D eye model to generate de-refracted eye parameters. The instructions when executed by the at least one processor individually or collectively, may cause the electronic device to estimate an optical axis of the de-refracted 3D eye model using the de-refracted geometric eye parameters. The instructions when executed by the at least one processor individually or collectively, may cause the electronic device to calibrate the optical axis with a plurality of calibration parameters to obtain the gaze information of the user. The instructions when executed by the at least one processor individually or collectively, may cause the electronic device to perform ray tracing on the de-refracted 3D eye model to project the de-refracted 3D eye model as the image prompt.

According to an embodiment of the disclosure, the instructions when executed by the at least one processor individually or collectively, may cause the electronic device to modify texture information of the random 3D eye model corresponding to the at least one eye. The instructions when executed by the at least one processor individually or collectively, may cause the electronic device to randomize eye color information of the random 3D eye model corresponding to the at least one eye. The instructions when executed by the at least one processor individually or collectively, may cause the electronic device to remove iris information from the random 3D eye model corresponding to the at least one eye. The instructions when executed by the at least one processor individually or collectively, may cause the electronic device to randomize skin contrast information of the random 3D eye model corresponding to the at least one eye.

According to an embodiment of the disclosure, the instructions when executed by the at least one processor individually or collectively, may cause the electronic device to provide, to the pre-trained AI model, a sample set of images and a sample set of randomized noise parameters. The instructions when executed by the at least one processor individually or collectively, may cause the electronic device to compress the sample set of images to translate the images in latent space. The instructions when executed by the at least one processor individually or collectively, may cause the electronic device to train the pre-trained AI model based on the translated set of images and the set of randomized noise parameters to generate a plurality of eye images without biometric information.

According to an embodiment of the disclosure, one or more non-transitory computer-readable storage media storing instructions that, when executed by at least one processor of an electronic device individually or collectively, cause the electronic device to perform operations may be provided. The operation may comprise obtaining a first image of at least one eye of a user. The operation may comprise extracting gaze information of the at least one eye, based on the first image. The operation may comprise generating an image prompt based on the gaze information of the user. The operation may comprise providing the image prompt with the gaze information to a pre-trained artificial intelligence (AI) model to generate a second image of the at least one eye of the user. The biometric information of the at least one of the user may be anonymized in the second image.

According to an embodiment of the disclosure, the operation may comprise providing the second image to an electronic device for tracking gaze of the user.

According to an embodiment of the disclosure, the operation may comprise performing feature extraction on the first image to extract geometric eye parameters associated with the at least one eye. The operation may comprise generating a three-dimensional (3D) eye model based on the geometric eye parameters. The operation may comprise obtaining the gaze information of the user based on the 3D eye model.

According to an embodiment of the disclosure, the geometric eye parameters may include at least one of eye radius, cornea radius, cornea information, ellipses of pupils, iris information, and index of refraction.

According to an embodiment of the disclosure, the operation may comprise initializing a random 3D eye model for the first image. The operation may comprise updating the random 3D eye model based on the geometric eye parameters until a loss function is less than a predetermined threshold. The operation may comprise comparing parameter of the random 3D eye model corresponding to each of the geometric eye parameters with each of the geometric eye parameters to calculate the loss function. The loss function may indicate deviation of the random 3D eye model from each of the geometric eye parameters. The operation may comprise determining whether the loss function is less than the predetermined threshold. The operation may comprise adjusting geometric and optic properties corresponding to each of the geometric eye parameters of the random 3D eye model based on the loss function, if the loss function is greater than a predetermined threshold. The operation may comprise providing the 3D eye model based on the updated random 3D model.

According to an embodiment of the disclosure, the operation may comprise de-refracting, using a de-refraction technique, the geometric eye parameters of the 3D eye model to generate de-refracted geometric eye parameters. The operation may comprise estimating an optical axis of the de-refracted 3D eye model using the de-refracted geometric eye parameters. The operation may comprise calibrating the optical axis with a plurality of calibration parameters to obtain the gaze information of the user. The operation may comprise performing ray tracing on the de-refracted 3D eye model to project the de-refracted 3D eye model as the image prompt.

According to an embodiment of the disclosure, the operation may comprise modifying texture information of the random 3D eye model corresponding to at least one eye. The operation may comprise randomizing eye color information of the random 3D eye model corresponding to the at least one eye. The operation may comprise removing iris information from the random 3D eye model corresponding to the at least one eye. The operation may comprise randomizing skin contrast information of the random 3D eye model corresponding to the at least one eye.

According to an embodiment of the disclosure, the operation may comprise providing, to the pre-trained AI model, a sample set of images and a sample set of randomized noise parameters. The operation may comprise compressing the sample set of images to translate the images in latent space. The operation may comprise training the pre-trained AI model based on the translated set of images and the set of randomized noise parameters to generate a plurality of eye images without biometric information.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing privacy enabled eye tracking performed by an electronic device, the method comprising:
obtaining a first image of at least one eye of a user;
extracting gaze information of the at least one eye, based on the first image;
generating an image prompt based on the gaze information of the user; and
providing the image prompt with the gaze information to a pre-trained artificial intelligence (AI) model to generate a second image of the at least one eye of the user,
wherein biometric information of the at least one of the user is anonymized in the second image.

2. The method as claimed in claim 1, further comprising:
providing the second image to a second electronic device for tracking gaze of the user.

3. The method as claimed in claim 1, wherein extracting gaze information of the at least one eye comprises:
performing feature extraction on the first image to extract geometric eye parameters associated with the at least one eye;
generating a three-dimensional (3D) eye model based on the geometric eye parameters; and
obtaining the gaze information of the user based on the 3D eye model.

4. The method as claimed in claim 3, wherein the geometric eye parameters include at least one of eye radius, cornea radius, cornea information, ellipses of pupils, iris information, and index of refraction.

5. The method as claimed in claim 3,
wherein the generating of the 3D eye model comprises:
initializing a random 3D eye model for the first image, and
updating the random 3D eye model based on the geometric eye parameters until a loss function is less than a predetermined threshold, and wherein the updating of the random 3D eye model comprises iteratively:
comparing parameter of the random 3D eye model corresponding to each of the geometric eye parameters with each of the geometric eye parameters to calculate the loss function, wherein the loss function indicates deviation of the random 3D eye model from each of the geometric eye parameters,
determining whether the loss function is less than the predetermined threshold,
adjusting geometric and optic properties corresponding to each of the geometric eye parameters of the random 3D eye model based on the loss function, if the loss function is greater than a predetermined threshold, and
providing the 3D eye model based on the updated random 3D model.

6. The method as claimed in claim 3, wherein obtaining the gaze information of the user based on the 3D eye model comprises:
de-refracting, using a de-refraction technique, the geometric eye parameters of the 3D eye model to generate de-refracted geometric eye parameters;
estimating an optical axis of the de-refracted 3D eye model using the de-refracted geometric eye parameters;
calibrating the optical axis with a plurality of calibration parameters to obtain the gaze information of the user; and
performing ray tracing on the de-refracted 3D eye model to project the de-refracted 3D eye model as the image prompt.

7. The method as claimed in claim 5, wherein the adjusting geometric and optic properties corresponding to each of the geometric eye parameters of the random 3D eye model comprises:
modifying texture information of the random 3D eye model corresponding to at least one eye;
randomizing eye color information of the random 3D eye model corresponding to the at least one eye;
removing iris information from the random 3D eye model corresponding to the at least one eye; and
randomizing skin contrast information of the random 3D eye model corresponding to the at least one eye.

8. The method as claimed in claim 1, further comprising:
providing, to the pre-trained AI model, a sample set of images and a sample set of randomized noise parameters;
compressing the sample set of images to translate the images in latent space; and
training the pre-trained AI model based on the translated set of images and the set of randomized noise parameters to generate a plurality of eye images without biometric information.

9. An electronic device for providing privacy enabled eye tracking, the electronic device comprising:
memory storing instructions; and
at least one processor communicatively coupled to the memory,
wherein the instructions, when executed by the at least one processor individually or collectively, cause the electronic device to:
obtain a first image of at least one eye of a user,
extract gaze information of the at least one eye, based on the first image,
generate an image prompt based on the gaze information of the user, and
provide the image prompt with the gaze information to a pre-trained artificial intelligence (AI) model to generate a second image of the at least one eye of the user, wherein biometric information of the at least one of the user is anonymized in the second image.

10. The electronic device as claimed in claim 9, wherein the instructions, when executed by the at least one processor individually or collectively, further cause the electronic device to:
provide the second image to a second electronic device for tracking gaze of the user.

11. The electronic device as claimed in claim 9, wherein to extract gaze information of the at least one eye, the instructions, when executed by the at least one processor individually or collectively, further cause the electronic device to:
perform feature extraction on the first image to extract geometric eye parameters associated with the at least one eye;
generate a three-dimensional (3D) eye model based on the geometric eye parameters; and
obtain the gaze information of the user based on the 3D eye model.

12. The electronic device as claimed in claim 11, wherein the geometric eye parameters include at least one of eye radius, cornea radius, cornea information, ellipses of pupils, iris information, and index of refraction.

13. The electronic device as claimed in claim 11,
wherein to generate the 3D eye model, the instructions, when executed by the at least one processor individually or collectively, further cause the electronic device to:
initialize a random 3D eye model for the first image, and
update the random 3D eye model based on the geometric eye parameters until a loss function is less than a predetermined threshold, and
wherein to update the random 3D eye model, the instructions, when executed by the at least one processor individually or collectively, further cause the electronic device to iteratively:
compare parameter of the random 3D eye model corresponding to each of the geometric eye parameters with each of the geometric eye parameters to calculate the loss function, wherein the loss function indicates deviation of the random 3D eye model from each of the geometric eye parameters,
determine whether the loss function is less than the predetermined threshold,
adjust geometric and optic properties corresponding to each of the geometric eye parameters of the random 3D eye model based on the loss function, if the loss function is greater than a predetermined threshold, and
provide the 3D eye model based on the updated random 3D model.

14. The electronic device as claimed in claim 11, wherein to obtain the gaze information of the user based on the 3D eye model, the instructions, when executed by the at least one processor individually or collectively, further cause the electronic device to:
de-refract, using a de-refraction technique, the geometric eye parameters of the 3D eye model to generate de-refracted eye parameters;
estimate an optical axis of the de-refracted 3D eye model using the de-refracted geometric eye parameters;
calibrate the optical axis with a plurality of calibration parameters to obtain the gaze information of the user; and
perform ray tracing on the de-refracted 3D eye model to project the de-refracted 3D eye model as the image prompt.

15. The electronic device as claimed in claim 13, wherein to adjust geometric and optic properties corresponding to each of the geometric eye parameters of the random 3D eye model, the instructions, when executed by the at least one processor individually or collectively, further cause the electronic device to:
modify texture information of the random 3D eye model corresponding to the at least one eye;
randomize eye color information of the random 3D eye model corresponding to the at least one eye;
remove iris information from the random 3D eye model corresponding to the at least one eye; and
randomize skin contrast information of the random 3D eye model corresponding to the at least one eye.

16. The electronic device as claimed in claim 9, wherein the instructions, when executed by the at least one processor individually or collectively, further cause the electronic device to:
provide, to the pre-trained AI model, a sample set of images and a sample set of randomized noise parameters;
compress the sample set of images to translate the images in latent space; and
train the pre-trained AI model based on the translated set of images and the set of randomized noise parameters to generate a plurality of eye images without biometric information.

17. One or more non-transitory computer-readable storage media storing instructions that, when executed by at least one processor of an electronic device individually or collectively, cause the electronic device to perform operations, the operations comprising:
obtaining a first image of at least one eye of a user;
extracting gaze information of the at least one eye, based on the first image;
generating an image prompt based on the gaze information of the user; and
providing the image prompt with the gaze information to a pre-trained artificial intelligence (AI) model to generate a second image of the at least one eye of the user,
wherein biometric information of the at least one of the user is anonymized in the second image.

18. The one or more non-transitory computer-readable storage media of claim 17, the operations, to extract gaze information of the at least one eye, further comprising:
performing feature extraction on the first image to extract geometric eye parameters associated with the at least one eye;
generating a three-dimensional (3D) eye model based on the geometric eye parameters; and
obtaining the gaze information of the user based on the 3D eye model.

19. The one or more non-transitory computer-readable storage media of claim 17, the operations, to generate of the 3D eye model, further comprising:
updating the random 3D eye model based on the geometric eye parameters until a loss function is less than a predetermined threshold,
wherein the updating of the random 3D eye model comprises iteratively:
comparing parameter of the random 3D eye model corresponding to each of the geometric eye parameters with each of the geometric eye parameters to calculate the loss function, wherein the loss function indicates deviation of the random 3D eye model from each of the geometric eye parameters,
determining whether the loss function is less than the predetermined threshold,
adjusting geometric and optic properties corresponding to each of the geometric eye parameters of the random 3D eye model based on the loss function, if the loss function is greater than a predetermined threshold, and
providing the 3D eye model based on the updated random 3D model.

20. The one or more non-transitory computer-readable storage media of claim 17, the operations, to obtain the gaze information of the user based on the 3D eye model, further comprising:
de-refracting, using a de-refraction technique, the geometric eye parameters of the 3D eye model to generate de-refracted geometric eye parameters;
estimating an optical axis of the de-refracted 3D eye model using the de-refracted geometric eye parameters;
calibrating the optical axis with a plurality of calibration parameters to obtain the gaze information of the user; and
performing ray tracing on the de-refracted 3D eye model to project the de-refracted 3D eye model as the image prompt.
